(19) United States
(12) Patent Application Publication
(10) Pub. No.: US 2016/0326765 A1
(43) Pub. Date: Nov. 10, 2016

(54) SYSTEMS AND METHODS FOR PROVIDING A PORTABLE WEATHER, HYDRATION, AND ENTERTAINMENT SHELTER

(71) Applicant: Scott Barbret, Long Beach, CA (US)

(72) Inventor: Scott Barbret, Long Beach, CA (US)

(21) Appl. No.: 15/148,853

(22) Filed: May 6, 2016

Related U.S. Application Data
(60) Provisional application No. 62/158,389, filed on May 7, 2015.

(51) Int. Cl. E04H 15/02; A45B 25/00; E04H 15/28; F25B 21/02; H02J 7/00; H02J 7/35; F24F 7/007; F24F 6/12; A45B 23/00; B65D 81/38

(52) U.S. Cl. CPC E04H 15/02; A45B 23/00; A45B 25/00; E04H 15/28; B65D 81/38; H02J 7/0044; H02J 7/35; F24F 7/007; F24F 6/12; F25B 21/02; A45B 2025/003; F24F 2006/146

(57) ABSTRACT

A system for providing a portable weather, hydration, and entertainment shelter, the system comprising an umbrella, a fluid delivery system, and a control panel, wherein: the umbrella comprises a support pole; the fluid delivery system comprises an insulated container having a fluid reservoir, and fluid tubing connecting the control panel and the fluid reservoir; the insulated container is further configured to receive to the support pole, and the control panel is configured to establish a fluid flow path between i) a spigot on the control panel and ii) the fluid reservoir.

This application claims the benefit of U.S. Provisional Application No. 62/158,389, entitled “SYSTEMS AND METHODS FOR PROVIDING A PORTABLE WEATHER, HYDRATION, AND ENTERTAINMENT SHELTER”, filed May 7, 2015, reference of which is hereby incorporated in its entirety.

### BACKGROUND

Umbrellas of various designs are well-known for protecting people from rain and sun. A hand-held umbrella typically protects one person from the elements, but may only be large enough to protect a single user. Larger umbrellas are commonly used on decks, patios, and around pools. These larger umbrellas are mounted on a pole and typically include a large weight, or extend through a table so as to be supported at the base and at a point on the pole above the base to provide additional support for an umbrella in the presence of wind. Large umbrellas are normally set up and maintained in one place and are not intended to be portable for traveling with a user. However, it is often desirable to have an enlarged expandable shelter which can be easily folded up and down for portability and for use by two or more people for protection from the sun and rain. These can be used at beaches and various outdoor scenarios away from a user's primary dwelling such as camping, concerts, festivals, and other similar venues. Such shelters typically require an additional point to secure the shelter such as an augured anchor or weighted base to prevent the shelter from blowing over or away in the presence of windy conditions.

### BRIEF DESCRIPTION OF THE DRAWINGS

A more detailed understanding may be had from the following description, presented by way of example in conjunction with the accompanying drawings, brief descriptions of which are listed below.

FIG. 1A depicts an overview of a portable weather, hydration, and entertainment shelter, in accordance with an embodiment.

FIG. 1B depicts a block diagram of a fluid delivery system, in accordance with an embodiment.

FIG. 1C depicts a perspective view of a portion of the portable shelter, in accordance with an embodiment.

FIG. 1D depicts a perspective view of a portion of the portable shelter, in accordance with an embodiment.

FIG. 2A depicts a perspective view of a portable shelter in a transport mode, in accordance with an embodiment.

FIG. 2B depicts an unassembled view of the terrain tires, in accordance with an embodiment.

FIG. 2C depicts a view of a portable shelter receiving a motorized cart, in accordance with an embodiment.

FIG. 3 depicts a schematic functional block diagram of an exemplary computer processing system in accordance with some embodiments.

### DETAILED DESCRIPTION

In accordance with an embodiment, a portable shelter comprises an umbrella, an electrical power distribution system, a fluid delivery system, and a control panel; the umbrella comprising a support pole, the electrical power distribution system comprising a power supply and distribution wires connected between the power supply and the control panel, the fluid delivery system comprising an insulated container having a first reservoir, fluid tubing connection between i) the control panel and ii) the first reservoir, and the control panel is configured to establish a flow path between i) a spigot on the control panel and ii) the first reservoirs. In an alternate embodiment, the fluid tubing connection is between i) the faucet and ii) the first reservoir, and the control panel is configured to establish a flow path between i) a spigot or faucet on the control panel and ii) the first reservoir.

In one such embodiment, the portable shelter comprises a second reservoir, the first and second reservoirs configurable to attach together and receive a support pole, and tubing connections between i) the control panel and ii) the either one or both of the first and second reservoirs, and a flow path between i) a spigot on the control panel and ii) either one or both of the first and second reservoirs.

In accordance with an embodiment, the reservoirs comprise two or more insulated reservoirs with carrying handles and depressions on the lids of the reservoirs for setting a cup or other vessel for convenience and ease of transport by the user. The insulated reservoirs contain liquid for consumption and hydration of the users and the reservoirs interlock to provide an opening configured to receive a post of the portable sun and weather shelter and form a stabilizing base.

In accordance with an embodiment, the reservoirs further comprise a telescoping handle.

In accordance with an embodiment, the portable shelter is configured to convey liquid from the reservoirs to a convenient pour spout or spigot via a segment that is either separate from or integrated into the frame of the portable sun and weather shelter. This may be accomplished via an electronic or manual pump integrated into the housing of the pole or one of the liquid reservoirs. The opening of the lids that will receive the umbrella when interlocked lids will have small reversible liquid and/or electronic connections to accommodate the tubing to convey the liquid via the pump to the pour handle. A small selector valve or buttons will be integrated into the housing on the pole to toggle between the different reservoirs.

In an alternate embodiment, the fluid delivery system comprises a pour spout disposed on a control panel, and a tubing system configured to convey fluid from the reservoir to the pour spout. The control panel may be attached to the insulated containers separate from the umbrella pole.

In accordance with an embodiment, the portable shelter is configured to convey fluid from one of the liquid reservoirs contained within the insulated containers or an alternate fluid source such as a faucet, stream, etc. to an optional fan and mist attachment placed on the post of the umbrella to cool a user if the shade provided by the portable umbrella shelter is not sufficient to comfort the user.

In accordance with an embodiment the portable shelter is configured to illuminate the space below the canopy to aid visibility to a user.

In accordance with an embodiment the portable shelter is configured to customize illumination for ease of identification of a user's umbrella for purposes of meeting in a crowded location such as a beach, concert, or festival where it is not easy to coordinate or distinguish or identify a meeting spot or pick out a base camp amongst the crowd.

In accordance with an embodiment the portable shelter further comprises a power inverter attached or otherwise in communication with the batteries housed within the umbrella or one of the insulated containers capable of transforming direct current to alternating current for charging a user's electronic devices or powering optional attachments, such as a blender, power tools, ancillary tools and the like.

In accordance with an embodiment, the insulated container of the portable shelter further comprises a thermo-electric cooling element. The thermo-electric cooling element may be a Peltier tile device and receive power from batteries or any other electrical power source and configured to absorb heat from or supply heat to the reservoirs.

In accordance with an embodiment the portable shelter further comprises a secure hardened plastic or hardened metal reversibly lockable box integrated into the lid or sides of the insulated reservoir for storage of a user's valuables. The reversibly lockable box may be weatherproof and be otherwise ingress protected.

In accordance with an embodiment, the lid of the insulated container is configured with a secondary-upper lid on a sliding track. The secondary-upper lid is configured to both i) rest on top of the reservoirs in a first position or ii) rest in a raised position along the sliding track and configured to act as a table surface. The first lid may be configured with a sliding panel to permit access to the contents of the lockable box without the requirement to open the lid.

In accordance with an embodiment, one of the insulated containers can be configured with a housing for a water filtration system. The water filtration system may be a fine particulate matter cylinder, an ultraviolet light cylinder, or the like. The water filtration system may receive water from an external water source, such as a lake, stream, or pond.

In accordance with an embodiment the portable shelter is configured to accept reversibly attachable tables that can be fixed to the pole or shaft of the umbrella.

In accordance with an embodiment the tables include a small inner tube contained within the rims of the tables that can be inflated to provide more surface area for grip of the wheels when the invention is being transported by the user.

In accordance with an embodiment the portable shelter further comprises a manual, battery powered, or electronic compressor for inflating the small inner tube or pressurizing the water tank for operating the optional mist/fan attachment. The compressor may also be configured to inflate an air mattress or other inflatable objects.

In accordance with an embodiment the umbrella pole or a segment of the support shaft is configured to reversibly attach to one of the insulated containers to act as an axle and the reversibly attachable tables are configured to be used as the wheels to roll the insulated container to and from a location by the user.

In accordance with an embodiment, small wheels of the insulated container can be configured to reversibly attach to accept larger diameter wheels for additional ground clearance to move the insulated containers and portable shelter more easily across a sandy beach or forest environment. Similarly, the small wheels may also be configured to attach to wheels of wider tread.

In accordance with an embodiment, the reservoirs can be configured to accept a motorized travel cart or dolly that can provide assistance moving the portable shelter across terrain. The motorized travel cart or dolly can house its own internal batteries or tie into a power supply associated with the portable shelter.

In accordance with an embodiment, the bottom of the insulated container can be configured with slide out tabs or legs configured to accept clamps to securely attach the insulated container to a tabletop or other raised surface.

In accordance with an embodiment, the slide out tabs or legs can be configured with holes to accept stakes to secure the container to the ground surface. Alternately, the legs may be restrained by weights, such as sandbags, metal, or liquid filled weights, to provide additional counterweight and support to the portable shelter.

In accordance with an embodiment the remaining umbrella pole or shaft segment is configured to reversibly attach to one or both of the insulated containers to act as a handle to pull the portable shelter when being transported by a user. In another embodiment, the remaining segment of the umbrella pole or shaft is configured to reversibly attach to the upper umbrella canopy and other segments to the insulated containers by folding during transport mode to act as a handle for pulling the portable shelter while being transported.

In accordance with an embodiment, the portable shelter further comprises an attachable solar panel that is connected to the top pole or shaft of the umbrella which is connected to a shaft and means of rotation to track the sun which is accomplished manually with a turn dial or via electronic communication with a sensor and small motor to automatically rotate the position to track the sun.

In accordance with an embodiment, the electronic connection of the solar panel in communication with the batteries housed in the lower portion of the portable shelter has buttons or a method of restricting full rotation of the solar panel as it tracks the optimal position of the to prevent the electrical connections from twisting.

The present disclosure describes systems and methods for providing a portable weather, hydration and entertainment shelter.

In at least one embodiment, a portable weather, hydration and entertainment shelter includes an umbrella with lights integrated into the canopy, at least one insulated liquid reservoir, at least one pump, first and second tubing systems to connect the liquid reservoir, or reservoirs, to a spigot or serving spout, a water connection for receiving liquid from an external water source, a battery, and a control module.

In at least one embodiment, the pump pumps a liquid through the first set of tubing with connected one-way flow valves (to prevent backflow into the alternate reservoirs) to a y or t valve where it is then released through the spigot or pour spout for serving the liquid into a cup or other drinking vessel.

In at least one embodiment, the first tubing system mechanically interconnects the liquid, the liquid reservoir, the pump, and the spigot.

In at least one embodiment, the second tubing system mechanically interconnects to the second liquid reservoir, the pump, and the spigot.

In at least one embodiment, the electrical connection for receiving power from a battery provides an electrical flow path from the electrical connection to the pump.

In at least one embodiment, the battery provides electrical power to the pump.

In at least one embodiment, the control module includes a mode selector control switch and an intensity selector control switch for the LED lights on the canopy frames.

In at least one embodiment, the portable weather, hydration and entertainment shelter includes an optional fan or fans attachment.

In at least one embodiment, the liquid contained within the reservoir is water.

In at least one embodiment, the liquid is another beverage, such as alcohol, juice, soda or a mixture of the two.

In at least one embodiment, the liquid reservoir is insulated. In at least one such embodiment, the liquid reservoir further includes a fill cap or opening lid, a drain tubing or fitting, and the insulated liquid reservoir is a source of potable liquid for hydration.

In at least one embodiment the tubing system can be connected to a hose, water faucet, or the like for flushing out the contents of the system for cleaning.

In at least one embodiment the first and second tubing systems can be connected via a manual or electronic solenoid valve for cycling a cleaning solvent through the overall tubing system during a cleaning cycle setting, whereby one of the pumps cycles the solvent or fluid through the system to sufficiently flush remaining contents or residue from the tubing systems.

In at least one embodiment the faucet, spout or spigot is a closed and sealed system, configured to accept a pressurized or carbonated beverage not requiring the pumps for serving or dispensing the liquids.

In at least one embodiment the liquid reservoir comprises a soft sided container and a plunger or other mechanism capable of compressing the liquid contained within to serve the beverage out of the faucet when not under sufficient internal pressure to flow out of the faucet on its own.

In at least one embodiment, the first reservoir tubing system includes quick-release interconnects so the internally housed tanks or containers can be quickly disconnected by the user for cleaning

In at least one embodiment, the second tubing system provides a flow path for potable liquid from the liquid reservoir to the first flow-control valve, the potable water to be used for hydration.

In at least one embodiment, the battery comprises a rechargeable battery. In at least one such embodiment, the battery receives an electrical charge when the device is connected to an external power supply.

In at least one embodiment, the battery comprises a replaceable battery.

In at least one embodiment, the canopy extensions or flaps include at least one attachment devices selected from the group consisting of zippers, snap buttons or Velcro strips.

In at least one embodiment, the internal battery is a rechargeable battery.

In at least one embodiment, the internal battery recharges when an external power supply is connected.

In at least one embodiment, the internal battery is a replaceable battery.

In at least one embodiment the internal battery housed within the lower umbrella pole segment has USB connections to power external devices when not connected to the umbrella.

In at least one embodiment, a portable weather, hydration and entertainment shelter includes an umbrella with lights integrated into the canopy, two liquid reservoirs, a pump, first and second tubing systems to connect the liquid reservoirs to a spigot or serving spout, a water connection for receiving liquid from an external water source, a battery, and a control module.

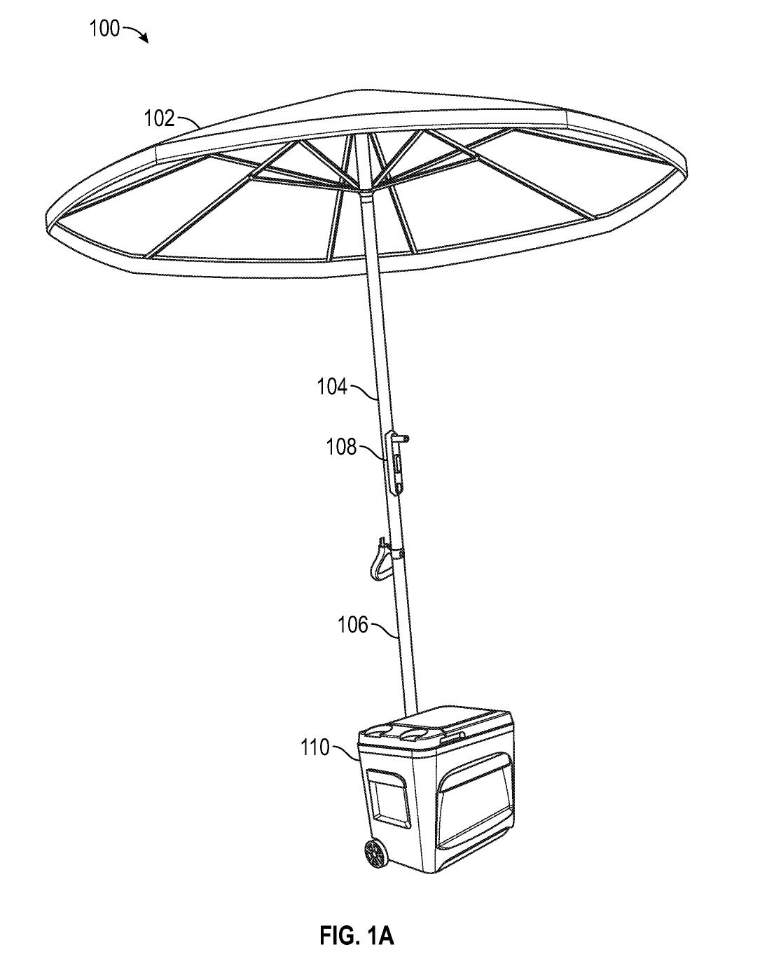

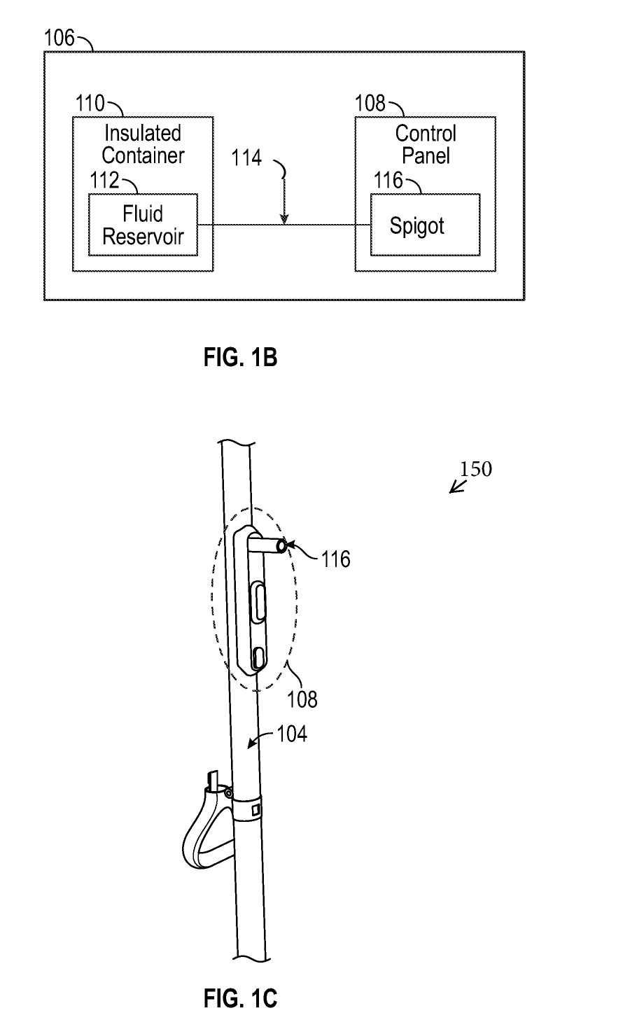

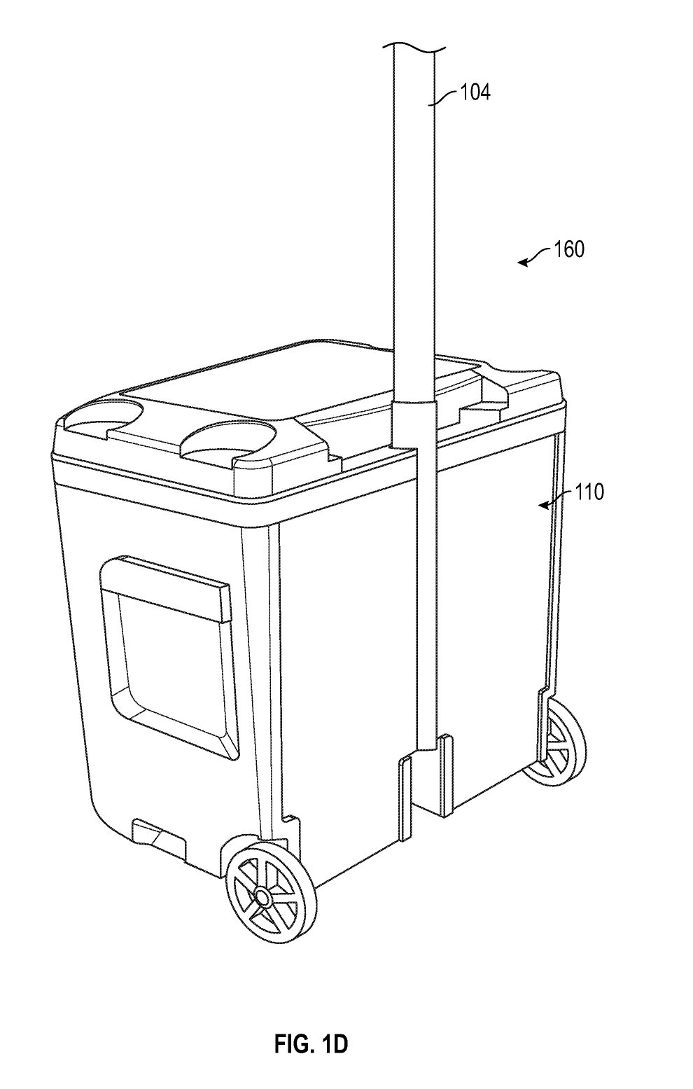

FIG. 1A depicts an overview of a portable weather, hydration, and entertainment shelter, (hereinafter “shelter” or “portable shelter”) in accordance with an embodiment. In particular, FIG. 1 depicts the portable shelter 100. The portable shelter 100 includes an umbrella 102 having a support pole 104, a fluid delivery system 106, a control panel 108, and an insulated container 110.

In this embodiment, the shelter of FIG. 1A is an example layout of a shelter, the details of which will be discussed in detail in conjunction with FIGS. 1B-1D, and throughout the specification. In various embodiments, some or all of the components of the shelter depicted in FIG. 1A may be omitted, moved in location, or modified in function, as known by one with skill in the relevant art.

In accordance with an embodiment, the portable shelter 100 includes the umbrella 102, the fluid delivery system 106, and the control panel 108, wherein: the umbrella 102 includes a support pole 104; the fluid delivery system 106 includes the insulated container 110 having a fluid reservoir, and fluid tubing connecting the control panel 108 and the fluid reservoir; the insulated container 110 is further configured to receive to the support pole 104, and the control panel 108 is configured to establish a fluid flow path between i) a spigot on the control panel and ii) the fluid reservoir.

In one embodiment, the insulated container is configured with slide out tabs at the base of the insulated container. The tabs are configured to accept clamps to securely attach the insulated container to a tabletop or other raised surface. The tabs may also comprise holes configured to accept stakes or screws to secure the container to a dirt or other ground surface. Alternately, the legs may receive additional weights, such as sandbags, metal, or water filled weights, to provide additional counterweight and support for the portable shelter.

FIG. 1B depicts a block diagram of a fluid delivery system, in accordance with an embodiment. In particular, FIG. 1B depicts the fluid delivery system 106 of shelter 100. The fluid delivery system 106 includes an insulated container 110 having a fluid reservoir 112, a control panel 108 having a spigot 116, and fluid tubing 114 connecting the fluid reservoir 112 to the spigot 116.

FIG. 1C depicts a perspective view of a portion of the portable shelter, in accordance with an embodiment. In particular, FIG. 1C depicts the perspective view 150. The perspective view 150 includes a portion of the support pole 104, the control panel 108, and the spigot 116.

The fluid tubing 114 provides a flow path between the fluid reservoir 112 and the spigot 116. It may further include other components such as a pump, flow control valves, break-away connections, and the like. In some embodiments, the fluid delivery system comprises a plurality of insulated containers, or each insulated container may comprise a plurality of fluid reservoirs. The fluid tubing is connected to the various components to permit multiple different fluids to flow from a respective fluid reservoir to the spigot 116. In an alternative embodiment, the control panel 108 may be configured with a plurality of spigots, each spigot capable of dispensing fluid from a fluid reservoir.

In some embodiments, the support pole 104 includes a folding handle. The folding handle may be located near a junction where a first portion of the support pole joins a second portion of the support pole. When the shelter is in a deployed configuration, the handle folds down to permit the first and second portions of the support pole to mate. When the shelter is in a transport configuration, the handle folds upwards and mates inline with the lower portion of the support pole. The handle may be used to push or pull the shelter in the transport configuration. The handle may latch with the support pole to keep in place.

FIG. 1D depicts a perspective view of a portion of the portable shelter, in accordance with an embodiment. In particular, FIG. 1D depicts the perspective view 160. The perspective view 160 includes the support pole 104 and the insulated container 110. The insulated container 110 is configured to receive the support pole 104.

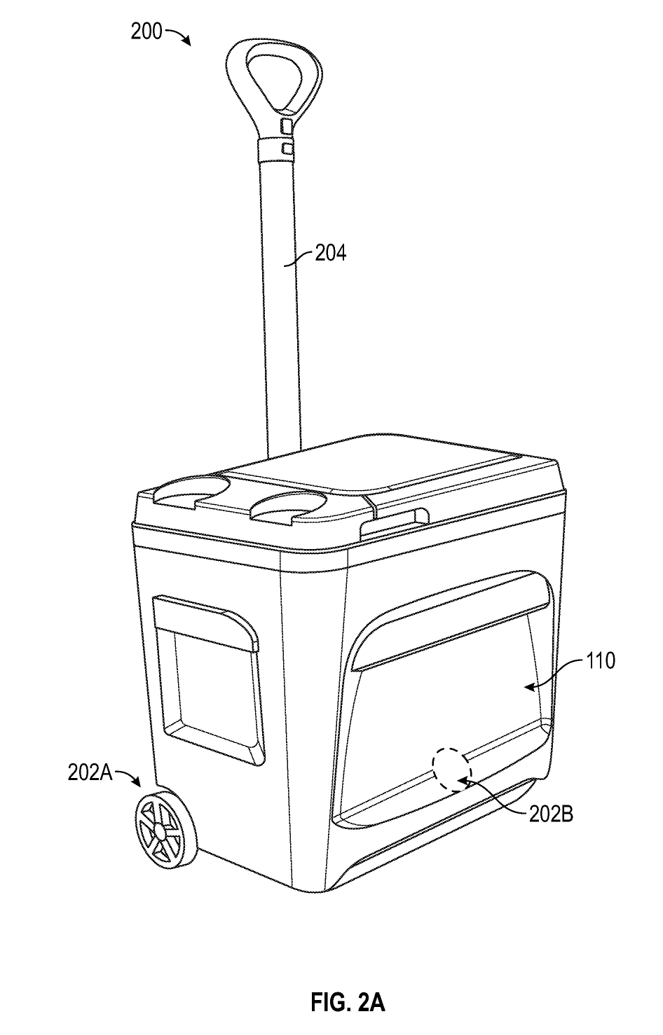

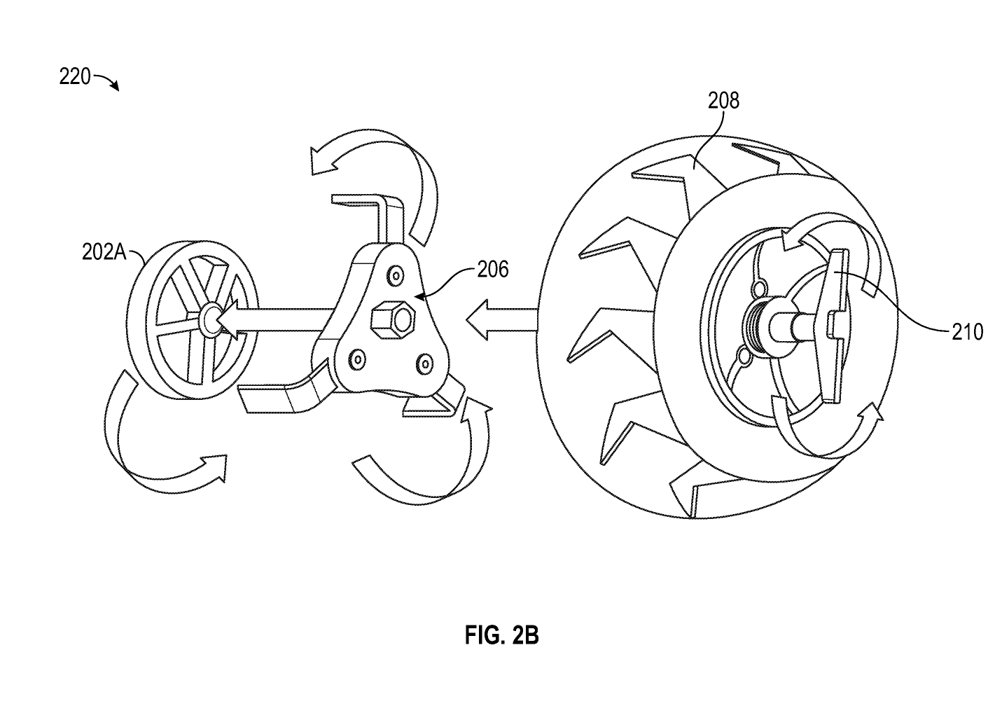

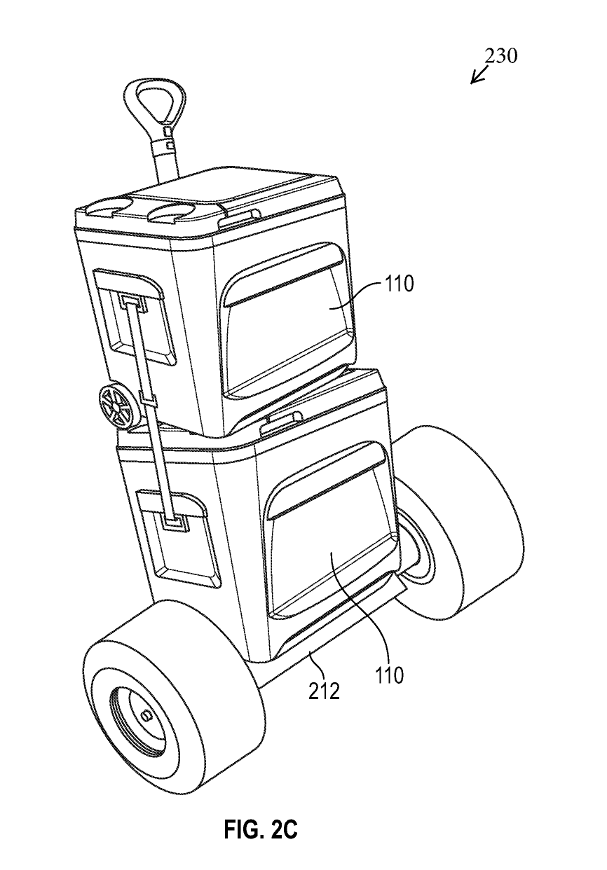

FIG. 2A depicts a perspective view of a portable shelter in a transport mode, in accordance with an embodiment. In particular, FIG. 2 depicts the view 200. The view 200 includes the insulated container 110, wheels 202A and 202B, and a portion 204 of the support pole. In the transport configuration, the portion 204 of the transport pole is attached to the insulated container 110. The wheels 202A and 202B are disposed on opposing sides of the insulated container 110.

FIG. 2B depicts an unassembled view of the terrain tires, in accordance with an embodiment. In particular, FIG. 2B depicts the view 220. The view 220 includes an insulated container wheel 202, a terrain wheel adapter 206, a terrain wheel 208, and a crank 210. In one embodiment, configuring the portable shelter to a transport mode comprises attaching the terrain wheel adapter 206 to either one or both of the container wheels 202A and 202B, attaching a terrain wheel 208 to the terrain wheel adapter 206, and tightening with crank 210.

FIG. 2C depicts a view of a portable shelter receiving a motorized cart, in accordance with an embodiment. In particular, FIG. 2C depicts the view 230. The view 230 includes a plurality of insulated containers 110 stacked on each other and a motorized cart 212. The insulated containers 110 receive the motorized cart 212 for ease of transport of the portable shelter.

The motorized cart may be a cart or a dolly and provide assistance in moving the containers. The cart may have its own internal batteries, or receive electrical power from batteries associated with the portable shelter.

In one embodiment, the insulated container comprises a thermoelectric cooling system configured to adjust a temperature of a fluid contained in the insulated container. The thermoelectric cooling system may be a Peltier tile able to either heat or cool the fluids contained in the insulated container. Operations of the thermoelectric cooling tile may be controlled via the control panel.

In one embodiment, the insulated container comprises a filtration system. The filtration system may be any filtration system, to include particulate filtration, UV filtrations, reverse osmosis, and the like.

In one embodiment, the control panel may be integrated into the support pole. In another embodiment, the control panel may be a standalone and not integrated into the support pole. In another embodiment, the control panel comprises a first control panel disposed on the support pole, and a second control panel disposed on the insulated container.

In accordance with an embodiment, the portable shelter 100 may also comprise a canopy, liquid reservoirs with integrated pumps, tubing and tubing interconnects, a pour spigot configured to dispense liquids stored in the liquid reservoirs flowing through the tubing and tubing interconnects, electrical connections configured to provide power from either a battery or an external power supply to the electrical loads attached to the portable shelter.

The portable shelter 100 may also comprise an awning or canopy, supported by canopy supports, and configured to open or close. The canopy and canopy supports attach to a center support pole. The center support pole may be segmented, for example into an upper segment and lower segment, or into an upper, middle, and lower segment. The support pole may be configured to store a battery and routing of electrical and fluid distribution systems, such as wires, tubing, and interconnects. The support pole may also be configured to route the electrical and fluid distribution system components. The support pole is configured to be inserted or attach to the lower reservoirs or insulated containers. The portable shelter may also include a control panel and various accessories, the various accessories comprising speakers, charging connections, lights, a cooling system, and a fluid dispensing system. The various accessories with the portable shelter are controlled by the control panel. The control panel may be configured to detect the identity of a user at the portable shelter, and activate the accessories, such as dispensing of liquids from the reservoir, permitting phone charging via the charging connections, activating the lights and cooling system, playing music and the like.

The upper portion of the portable shelter comprises an electric eye, a solar panel, a solar connection point, a canopy frame support connection, LED lights, an upper umbrella canopy “parachute” vent, a canopy frame extension, canopy slide-able frames, a canopy slide-able collar, a canopy tilt mechanism, a reversible canopy extension connection, a solar panel motor, a solar panel manual dial, a solar panel connector, and a quick release rotating mount.

In some embodiments, the solar panel collects solar energy and converts the solar energy to electricity. The electricity is utilized to power various electrical loads associated with the portable shelter, to include the shelter's batteries, pumps, charging connections, lights, and control panel. The solar panel may further comprise an electric eye. The electric eye is configured to detect the position of the sun, and in conjunction with the motor and connector, reposition the solar panel in response to input from the electric eye. The solar panel is capable of being removed from the portable shelter via the quick release rotating mount. The solar panel is electrically connected via a wiring system to the solar panel electrical distribution system, as known by those with skill in the art.

In accordance with an embodiment a canopy is attached to the canopy frame extensions. When the canopy slide-able collar is raised upwards along a support shaft, the canopy slide-able frames exert a force to the coupled canopy frame extensions causing the canopy to open to a polygon or circular surface. The canopy frame extensions may be configured to increase in axial length. The canopy can be extended to connect to the extended canopy frame extensions. This raises the surface area of the protected area under the canopy. The canopy may also be equipped with parachute-like wind releasing vents or flaps.

In accordance with an embodiment, the middle portion of the portable shelter 100 may comprise, a fan attachment, a mist fitting, a fan, an umbrella support pole segment, a reversible electrical connection associated with the fan or mist attachment, a reversible tubing connection for the fan or mist attachment, a power inverter, charging connections (USB, 120V, etc), a ventilation fan, control buttons, crank mechanism, a spigot, a speaker, a reservoir selector, a momentary switch associated with a first liquid reservoir pump, a momentary switch associated with a second liquid reservoir pump, a control panel, a segmented umbrella pole table, a cup holder, a vented mesh drain, a skirt configured to prevent liquids from entering lower segment, and a shroud configured to conceal tubing and electrical connections.

In accordance with an embodiment, the portable shelter 100 may be equipped with a personnel cooling system. The personnel cooling system may comprise one or both of a fan and mister. The fan is mounted to the support pole via the attachment device. The fan receives electrical power from the electrical supply system associated with the portable shelter. The mister is configured to receive pressurized water from a tubing system associated with the portable shelter. The water may be pressurized from an electric pump, a manual pump, an air compressor, or the like. The mister is configured to spray the pressurized water in small droplets.

In accordance with an embodiment, the portable shelter may be equipped with fluid dispensing system. The fluid dispensing system may comprise a means to select a fluid from a plurality of reservoirs (such as the selectors) a spigot, and an actuator (such as the momentary switches). The fluid dispensing system receives a liquid through a tubing system associated with the portable shelter. The fluid may be stored in a reservoir associated with the portable shelter.

In accordance with an embodiment, the lower portion of the portable shelter comprises a lower pole segment, batteries, a power connection module, a lower cap, a liquid reservoir, a reservoir lid, a reservoir handle, a cup holder, a reservoir lid securing device, a reservoir-interconnect connection point, an anchor, and an external plumbing connection.

In accordance with an embodiment, the lower pole segment is hollow, with space to enclose the batteries. The battery may be a single battery, a plurality of batteries, single use batteries, rechargeable batteries, Lithium Ion batteries, NI-MH, Polymer, Graphene, any standard single use alkaline batteries (AA, AAA, C, D, 9v, etc.), or any other battery suitable as a power supply, as know by those with skill in the relevant art. Alternatively, the battery may also be located in a portion of a lower reservoir or insulated container, with additional electrical interconnects to power the portable shelter.

The bottom portion of the lower pole segment is able to mate with the cap either with threads, a twist-and-lock connection, used in conjunction with a sealing gasket. Attached in the lower pole segment is a power connection. The power connection is configured to charge the battery from an external power source. The power connection may take the form of a standard power connector, a custom power connector, a USB port, or the like.

The insulated container may be a single piece or two separate insulated containers. In embodiments with two separate insulated containers. The two insulated containers can be interlocked with an insulated-container-interconnect connection. The insulated-container-interconnect connection may take the form of a tab-and-slot, with one insulated container having a tab, and the other insulated container having a slot configured to receive the tab, be magnetically interconnected, or the like. The insulated container may also include insulation configured to reduce thermal conductivity to or from another liquid stored in the insulated containers. The liquid stored in the reservoirs is able to flow through tubing to the control panel. Additional equipment may also be included in the insulated container, to include liquid reservoirs, a battery, a pump, a filtration system, and the like. In embodiments with a single insulated container, the single insulated container is configured to receive and retain the support pole.

In accordance with an embodiment with two separate insulated containers, the fluid flow paths from the two separate insulated containers to the spigot are separate, and the spigot comprises two chambers and two separate holes to prevent cross-contamination of the liquids from the separate insulated containers.

The insulated container can store either cold or hot liquids. Example cold materials include ice, cold water, dry ice, and the like. Example hot materials includes hot water, coffee, tea and the like. The liquid inside each insulated container is separated from the liquid housed in the other insulated container, however, the liquid is able to be mixed at the point of serving by toggling a selector switch or valve, or in an alternate embodiment depressing the two momentary switches at the same time. The insulated liquid reservoir is insulated from surrounding atmosphere to minimize heat loss to the surroundings.

The control module/user interface directs flow of liquid from one or both of the liquid reservoirs to the pour spout or spigot via the flow valves or by depressing the momentary switch or multiple position toggle switches to dispense the liquid. The connections between the spigot tubing housed in the upper umbrella pole segment are push to disconnect or break away couplings, designed to release under tension.

The liquid reservoir comprises the fill cap or lid, internal flow pipes, and a connection point. The insulated liquid reservoir is filled with either hot or cold liquid, or similar materials through the fill cap or lid. The heat transfer liquid is able to flow through the insulated liquid reservoir to dispense the liquid through the pour spigot or spout housed on the upper pole segment.

The liquid reservoirs are configured with male quick-connect fittings that are configured to accept a female quick connect spigot or faucet so they can be used to dispense liquid in a refrigerator while the male fittings are also configured to quickly attach and detach from the plumbing and fluid connections of the insulated container and the control panel segment.

The control panel housing also comprises the mode selector switch, and user interface for dispensing liquid. The momentary switch or button and the flow valves control the amount of liquid to be dispensed and can be stopped by releasing the button or closing the valves. The mode selector switch comprises a master on/off switch for the control panel, selector switch for the lights, and a power switch for an automatic motor crank to deploy the canopy among other functions.

The insulated container is further configured to receive the support pole. The insulated container, or insulated containers, serve as a support base for the portable structure. The portable shelter may also comprise an anchor. The anchor may take the form of a flat base, an auger, or both. The interconnecting valves are used in components that it is desirable to disconnect under tension force. Example tensile forces that the connections disconnected should be between 10 to 15 lbs of pressure. Example interconnections include the connection points between the upper umbrella pole segment and the tubing connected to the lower liquid reservoirs. In various embodiments, the valves that disconnect under tension are the connection points between the control panel and the reservoirs.

The pump comprises electrical connections an inlet nozzle, outlet nozzle, and a power supply cord. The power supply cord receives power from either the external power supply or the internal battery. The housing may be water and dust ingress protected.

In accordance with an embodiment, the insulated container of the portable shelter may include the lower pole shroud, a pump, tubing, fluid interconnects, electrical interconnects, an anchor attachment point, and a recessed cavity configured to accept a support pole associated with the portable shelter.

The pump may be electrically powered (via electrical interconnects, or manually powered, such as a foot or hand actuated bulb pump) and be configured to exert pressure on the fluid contained in the reservoir, directly or indirectly. The fluid from the reservoir, aided by the pump, is able to flow into the tubing for delivery throughout the portable shelter. In accordance with an embodiment, the liquid in the reservoir could be water, routed via the tubing to the spigot for drinking water or the mister for cooling. The anchor attachment point is configured to mechanically connect the liquid reservoir to an anchor, such as the flat base or the auger.

In accordance with an embodiment, the portable shelter may comprise a control panel The control panel may include electrical connections and tubing connection for the cooling device, the charging connections, the vent, control buttons, the crank mechanism, the spigot, the speaker, the momentary switches, a check valve, a Y-splitter valve, a battery indicator configured to display stored energy in the battery, a spigot connection, a control module associated with lighting, electronic accessory charging cords, a seat, and a retention band.

The tubing connection is configured to route liquid from the reservoirs to the spigot assembly and tubing interconnects, and others, or to the cooling system for use by the misters.

The speaker is configured to play an audio signal. The audio signal may be produced by an electronic accessory plugged into the accessory charging cords, via a capability for the charging cords ability to convey electrical charge and data. Additionally, the speaker may receive the audio signal via a wireless signal, such as WiFi or Bluetooth, as know by those with skill in the relevant art. The speaker is held in place via a restraining band, a reversible clip, or the like.

In an embodiment, the control panel comprises at least a mode control selector, a spigot, faucet, or spout, a seat for a power inverter to electrically communicate with a solar panel or other peripherals, seat for a smartphone, small speaker or other electronic device, and various electrical connections and buttons or switches to connect and operate peripherals connected to the control panel. The selectors are depicted as circular buttons and are situated on a housing that encloses the power inverter module and pour spout/spigot housing.

The control panel may also comprise other control elements. The control panel can be configured to control power to the pump, lights and other portions of the portable shelter. In some such embodiments, the control panel determines electrical power available and supplies electricity to the various components of the weather, shade and entertainment shelter. When the control panel detects an external power supply, the control panel directs electrical power to the liquid conditioning device and the pump. When the external power supply is not detected, such as by a change in voltage, or lack of voltage, or in other methods known by those in the art, the control panel directs electrical power to the power inverter and does not supply power to the attached peripherals.

In various embodiments, the control panel also is a weather (water and dust) proof enclosure. The control panel may also provide indicating lights, auxiliary power supplies (such as a USB port for a phone, may be wirelessly or wired communicatively to a separate user interface as known by those with skill in the art. In embodiments that comprise a separate user interface, the separate user interface may be a wired control extender, the control extender to allow a user to place the controls in a more convenient location, or it may be a wireless connected user interface, such as through a Bluetooth connection to a personal smart phone, a network server, or the like. The wireless interface may be able to receive commands to control the various element of the weather, shade and entertainment shelter through voice control, through integrated controls, or the like.

The control panel may further comprise additional lighting. The additional lighting may be LED lights and be disposed on the control panel. A light actuator may be configured to illuminate the canopy lights when the canopy is installed and operate the additional lighting on the control panel when the canopy is not installed. This configuration enables the additional lighting to assist in illuminating the portable shelter during disassembly.

In an embodiment, the control panel is further configured to receive indications from sensors associated with the portable shelter and convey the received indications to a network. Example sensors include a thermocouple or other temperature sensing sensor, a level detector, and a charge indicator. The temperature sensing sensor may measure the temperature of the liquid from the reservoir. The temperature sensor may be continuously transmitted to the network, periodically transmitter, or only when a pre-determined threshold is reached, such as when a liquid is too cold or too hot. Similarly, a level detector may detect the level of liquid in the reservoir, and the control panel may transmit the detected level via the network. Similarly, the charge of the battery may also be detected and transmitted via the control panel to the network. The reports permit notification and monitoring of the portable shelter to service staff that are able to refill, recharge, or replenish the portable shelter.

The portable shelter may comprise data and power connections, in accordance with an embodiment. The data and power connections may include the power connection module. The power connection module comprises both USB data and charging ports and an electric connector port. The module contains threads to mate with a waterproof cap and a lower segment of the support pole threaded waterproof cap for the bottom of a lowest umbrella pole segment housing may be used for the batteries, in accordance with an embodiment.

In an embodiment, the lowest umbrella pole segment is sealed and electrical connections and USB ports are routed through the top segment of the umbrella support pole. In accordance with an embodiment, a plurality of portable shelters may be interconnected. In particular, each of the portable shelters are interconnected to form a continuous shelter. Additionally, the portable shelters may also include a canopy extension, with triangles extending from the left and right sides of the left and the right canopies, respectively. The canopy extension is also equipped with a canopy extension anchor connection point, configured to anchor the canopy extension to the ground, or other suitable connection point.

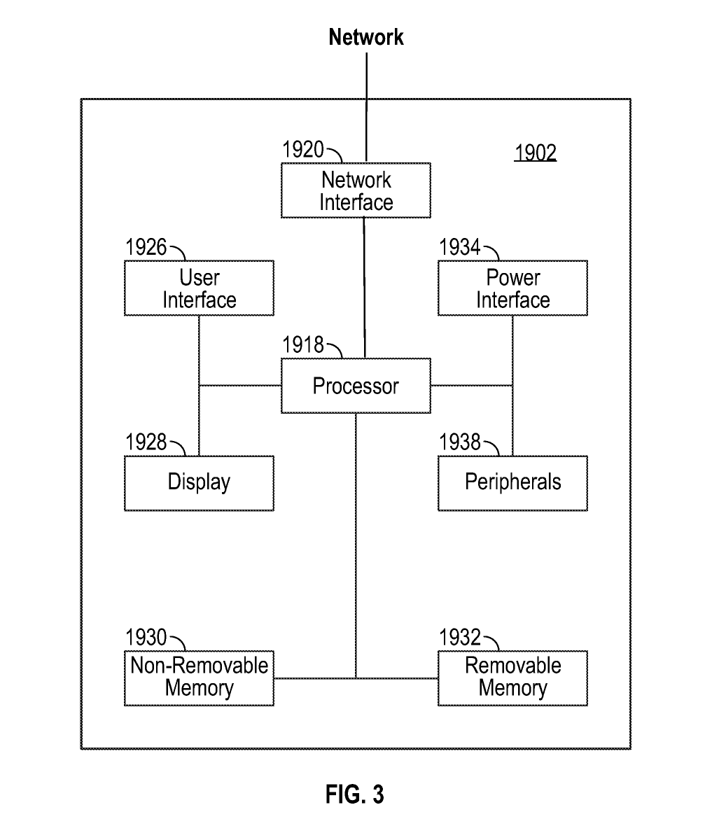

FIG. 3 depicts a schematic functional block diagram of an exemplary computer processing system in accordance with some embodiments. A computer processing system may be used to control portions of the portable weather, shade and entertainment shelter. The computer processing used may be a generic computer processing system capable of carrying out the disclosures of this invention. Some functions that may be completed with the computer processing system include control of the control panel, transmission of sensor data to a network, and the like. Example computer processing systems include smart phones, phones, laptops, computers, car navigation systems, RF remotes and the like. The computer processing systems may be connected to remote and local networks or other remote computer processing systems. The functions described as being carried out in one computer processing system may also be carried out in a remotely connected computer processing system, as known by those with skill in the relevant art. It may be appreciated that the methods of this disclosure are completed on multiple computer processing systems which are communicatively coupled together.

In some embodiments, the systems and methods described herein may be implemented in a computer processing system, such as the computer processing system 1902 illustrated in FIG. 3. As shown in FIG. 3, the computer processing system 1902 may include a processor 1918, a network interface 1920, a user interface 1926, a display 1928, a non-removable memory 1930, a removable memory 1932, a power source 1934, and other peripherals 1938. It will be appreciated that the computer processing system 1902 may include any sub-combination of the foregoing elements while remaining consistent with an embodiment. The computer processing system may be in communication with the internet and/or with proprietary networks.

The computer processing system 1902 can incorporate the embodiments of this disclosure. For example, the peripherals 1938 may include the internal sensor, the external sensor, and any optional auxiliary sensors. The display 1928 may include the virtual reality display, and any optional audio speakers. The network interface may include the communication interface.

The processor 1918 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1918 may perform signal coding, data processing, power control, input/output processing, and/or any other functionality that enables the server 1902 to operate in a wired or wireless environment. The processor 1918 may be coupled to the network interface 1920. While FIG. 3 depicts the processor 1918 and the network interface 1920 as separate components, it will be appreciated that the processor 1918 and the network interface 1920 may be integrated together in an electronic package or chip.

The processor 1918 of the server 1902 may be coupled to, and may receive user input data from, the user interface 1926, and/or the display 1928 (e.g., a liquid crystal display (LCD) display unit or organic light-emitting diode (OLED) display unit). The processor 1918 may also output user data to the display/touchpad 1928. In addition, the processor 1918 may access information from, and store data in, any type of suitable memory, such as the non-removable memory 1930 and/or the removable memory 1932. The non-removable memory 1930 may include random-access memory (RAM), read-only memory (ROM), a hard disk, or any other type of memory storage device. In other embodiments, the processor 1918 may access information from, and store data in, memory that is not physically located at the server 1902, such as on a separate server (not shown).

The processor 1918 may receive power from the power source 1934, and may be configured to distribute and/or control the power to the other components in the server 1902. The power source 1934 may be any suitable device for powering the server 1902, such as a power supply connectable to a power outlet.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

In accordance with an embodiment, the portable shelter comprises a lockable compartment, an accessory mount, a blender, and the umbrella canopy inserted into the middle segment, and the associated electrical connections for canopy lights.

The lockable compartment, is part of an enclosure associated with the reservoir. The lock may be locked and unlocked with a key, or the locking mechanism may be activated via the control panel, subsequent to an identification verification. The identification verification may be either detecting a wristband, an RF connection, or the input of a PIN number or password on the control panel. In the depicted embodiment, the lockable compartment is an aluminum lockbox embedded in the lid of a thermally insulated reservoir.

In some embodiments, the lockable compartment is on a lower lid of the insulated container. The lower lid of the insulated container may be configured with a secondary upper lid on a sliding track attached to the lower lid. The upper lid may slide out and provide extra surface area to act as a table. The lockable compartment may be weatherproof or otherwise ingress protected.

The blender is attached to an accessory mount. The accessory mount is fixed on the reservoir, or the lid of a reservoir. The blender is attached via a twist lock to the aluminum lock box and is powered from the portable shelter, either by being electrically connected to an inverter or the system's batteries.

In some embodiments, the portable shelter comprises a Near Field Communications (NFC) chip reader, a Bluetooth speaker, a 12V to 2-way USB splitter, solenoid valves, a splitter manifold, a power inverter, a faucet, momentary buttons, a speaker controller, a computer processing system, an electronic lock, and a channel.

The NFC Chip is part of an identification system. The NFC Chip is configured to detect an NFC chip reader associated with an individual and communicate the detection of the NFC chip to the computer processing system associated with the control panel. The NFC chip can also be substituted with other devices to implement other methods of identity verification. These methods may include a card reader scanning a magnetic strip on a hotel key card, a user entering a password via a user interface, scanning of a bar code or a QR code, or the like.

The solenoid valves are configured to control access to beverages dispensed by the fluid dispensing system. The fluid dispensing system also comprises a splitter manifold to connect multiple beverages, momentary waterproof buttons, and a faucet. The solenoid valves may actuate, and permit fluid to flow through the fluid dispensing system in response to an actuation of a momentary button and the results of an identification verification.

The speaker may comprise a waterproof Bluetooth speaker and be configured to receive control signals from the speaker remote. The speaker remote communicates with the speaker through a wired or wireless connection and is capable of communication control signals, such as volume changes, play controls, input selections, and the like.

Components of the electrical distribution system include a 12V to 2-way USB splitter and a power inverter. The USB splitter is configured to receive electrical power from the electrical distribution system and power electronic accessories plugged into the USB portion of the splitter. Alternatively, the portable shelter may receive electrical power from an external source plugged into the USB ports of the USB splitter to charge the battery or power the portable shelter's electrical loads. The inverter is capable of powering the blender for 1 minute or charging a laptop.

In accordance with an embodiment, the support pole of the umbrella may comprise a beach auger/anchor, a capped waterproof electrical cigarette plug connector, and a 25 Amp-hour battery capacity housed within the lower tube 12V.

In accordance with an embodiment, the portable shelter may comprise a solar tracking module and a solar panel, in accordance with an embodiment. The solar tracking module is configured to detect a source of light, such as the sun. The solar tracking module communicates the status of the detected light source to a computer processing system associated with the portable shelter and the motor rotates the solar panel in response to the detected position of the source of light.

In accordance with an embodiment, the portable shelter may comprise a power inverter and a swappable battery compartment. The shelter includes. a first lidded compartment, an output power inverter, and a second lidded compartment, a power inverter and a swappable battery. The first lidded compartment is configured to store the output power inverter. The output power inverter is configured to supply electrical power to high current devices such as power tools, blenders, and the like. The second lidded compartment is configured to store swappable batteries, which are additional sources of electrical power.

In accordance with an embodiment, the portable shelter may include a panel mount electrical connection for a pump, a quick release self-sealing quick release fitting configured to connect the pump to the spigot for serving beverages, and a tube configured to fit over the lower pole segment.

In accordance with an embodiment, the portable shelter may include an air compressor, a ball joint mount, a sealed reservoir, a flow adjuster valve, water quick connections, a pump, and a fan adjustment control.

The air compressor is configured to pressurize a reservoir for either the fan and mist attachment or for the liquid dispensing system. The air compressor may either be electrically powered or manually powered, such as a bulb or “bicycle type” chamber compressor.

The ball joint is configured to secure fans to the portable shelter and for adjusting location and position of the fans. The speed of the fan is adjustable via the variable speed control button.

The sealed reservoir is a three gallon sealed water container that is able to be placed inside the reservoir associated with the portable shelter. The reservoir comprises a quick connect fitting configured to receive a connection from a fluid supply.

In accordance with an embodiment, the portable shelter includes a table, a shroud, straps, a handle, a waterproof cap, a first reservoir, a second reservoir, and a support pole.

The transport mode, may include the same elements of the portable shelter in a new configuration. The wheels of the portable shelter in the transport mode comprise disk shaped circular objects associated with the portable shelter. Each wheel may be the pole-mounted table (such as the segmented umbrella pole table), the flat base (such as weighted patio anchor), or the like. The wheels are circular and of similar radial dimensions. Each of the left wheel and the right wheel is configured to be mounted on an axel.

The wheels of the portable shelter may further comprise an inflatable ring along the circumference of the wheel. The inflatable ring may be pressurized either manually by a user, or from a pump associated with the portable shelter.

The axel may be the shroud, or any of the support pole segments, or a combination of both. In one embodiment, the support pole is configured to be divided into at least two segments. The first segment of the support pole is an upper portion of the support pole, and is configured to act as a handle in the transport mode. The canopy is fully collapsed around the first segment. One end of the first segment attaches to a base, either at the reservoir or the axle. The opposite end of the first segment as a handle. The first segment of the support pole may be configured to attach to the cavity of reservoirs which received the support pole in the portable shelter configuration.

A second segment of the support pole is configured to be an axle in the transport mode. The axle may comprise both the second segment of the support pole and the shroud. The second segment is configured to attach to the reservoir or the first segment of the support pole. The arrangement of the first and second segment of the support pole, when configured for transport, is approximately perpendicular. The second segment may further comprise collars configured to prevent remove sand and debris from the second segment, preventing foreign material from scratching the segment while rolling. The collars are either solid or pushed from the bottom into spring clamps to attach the wheels to the axle.

The reservoirs are configured to stack on top of each other and be restrained to the support pole. The stacking configuration is aided by the feet, located on the bottom of a reservoir, inserting into cup holders, located on the top of the reservoir. Either one, or both, of the reservoirs is secured to the support pole via a strap. In the transport mode, the first segment acts as the handle, the second segment acts as the axle, and the tables act as the wheels. In the transport mode, the portable shelter can be moved like a pull-cart.

1. A portable shelter comprising:
an umbrella having a support pole;
a fluid delivery system having an insulated container having a fluid reservoir, and fluid tubing connecting the control panel and the fluid reservoir;
the insulated container is configured to receive to the support pole, and a control panel configured to establish a fluid flow path between i) a spigot on the control panel and ii) the fluid reservoir.

2. The portable shelter of claim 1, further comprising a battery disposed inside the insulated container.

3. The portable shelter of claim 1, further comprising a battery disposed inside the support pole.

4. The portable shelter of claim 1, further comprising a charging system configured to charge a rechargeable battery.

5. The portable shelter of claim 1, the control panel further comprises a charging port configured to recharge a portable electronic device.

6. The portable shelter of claim 5, wherein the charging port is configured to provide an electrical charge in response to verifying an identity of a user.

7. The portable shelter of claim 1, further comprising a personnel cooling system.

8. The portable shelter of claim 7, wherein the personnel cooling system comprises a fan.

9. The portable shelter of claim 7, wherein the personnel cooling system comprises a mister configured to receive fluid from the fluid reservoir.

10. The portable shelter of claim 1, reconfigurable to a transport configuration, wherein the transport configuration comprises:
a first and second wheel attached to opposite ends of the insulated container, and a segment of the support pole attached to the insulated container substantially perpendicularly to a ground surface.

11. The portable shelter of claim 10, wherein the first and second wheels configured to receive terrain wheels.

12. The portable shelter of claim 10, wherein in a transport configuration, the portable shelter is configured to receive an external motorized cart.

13. The portable shelter of claim 1, wherein the insulated container comprises a thermoelectric cooling system configured to adjust a temperature of a fluid contained in the insulated container.

14. The portable shelter of claim 1, wherein the insulated container comprises a filtration system.

15. The portable shelter of claim 14, wherein the filtration system comprises a UV filtration system and a particulate filtration system.

16. The portable shelter of claim 1, further comprising a loudspeaker.

17. A portable shelter of comprising:
an umbrella having a support pole;
a fluid delivery system having a first insulated container and a second insulated container, wherein:
at least one of the first and the second insulated containers comprise a fluid reservoir;
the first insulated container is configured to attach to the second insulated container; and
the support pole is configured to attach, via a breakaway connection, to either one or both of the first and second insulated containers; and
a control panel configured to establish a fluid flow path between i) a spigot on the control panel and ii) the fluid reservoir.

18. The portable shelter of claim 17, wherein one of either the first or the second insulated containers comprises a filtration system.

19. The portable shelter of claim 17, wherein one of either the first or the second insulated containers comprises a thermoelectric cooling system configured to adjust a temperature of a fluid contained in the insulated container.

20. The portable shelter of claim 17, reconfigurable to a transport configuration, wherein the transport configuration comprises:
one of either the first and second insulated containers stacked above the other of either the first and second insulated containers;
wheels attached to a lower insulated container of the stacked insulated containers; and
a segment of the support pole attached to either one of either the first and second insulated containers substantially perpendicularly to a ground surface.
